(19) United States
(12) Patent Application Publication
(10) Pub. No.: US 2026/0153048 A1
(43) Pub. Date: Jun. 4, 2026

(54) FLOW CHANNEL STRUCTURE AND CYLINDER BLOCK

(71) Applicant: ISUZU MOTORS LIMITED, Yokohama-shi, Kanagawa (JP)

(72) Inventors: Yusuke KIMURA, Fujisawa-shi, Kanagawa (JP); Shinichi HONMA, Fujisawa-shi, Kanagawa (JP)

(21) Appl. No.: 18/724,011

(22) PCT Filed: Sep. 15, 2022
(86) PCT No.: PCT/JP2022/034529

§ 371 Date: Jun. 25, 2024

(30) Foreign Application Priority Data
Dec. 27, 2021 (JP) 2021-212684

(51) Int. Cl. F01P 3/02; F02F 7/00

(52) U.S. Cl. CPC F01P 3/02; F02F 7/007

(57) ABSTRACT

The flow channel structure, which is provided to a component member of an engine and through which the coolant used for cooling the engine flows, comprises: a plurality of water jackets; one bypass channel provided in parallel to the plurality of water jackets; a branch channel that branches the coolant pressure-fed by a water pump so as to flow into the most-upstream-side water jacket among the plurality of water jackets and the most-upstream-side part of the bypass channel; and a plurality of connection channels that respectively connect the plurality of water jackets to the bypass channel. The plurality of connection channels are connected to the bypass channel at mutually different positions from the upstream to the downstream of the bypass channel, and the flow channel cross-sectional areas of the plurality of connection channels increase toward the downstream side of the bypass channel.

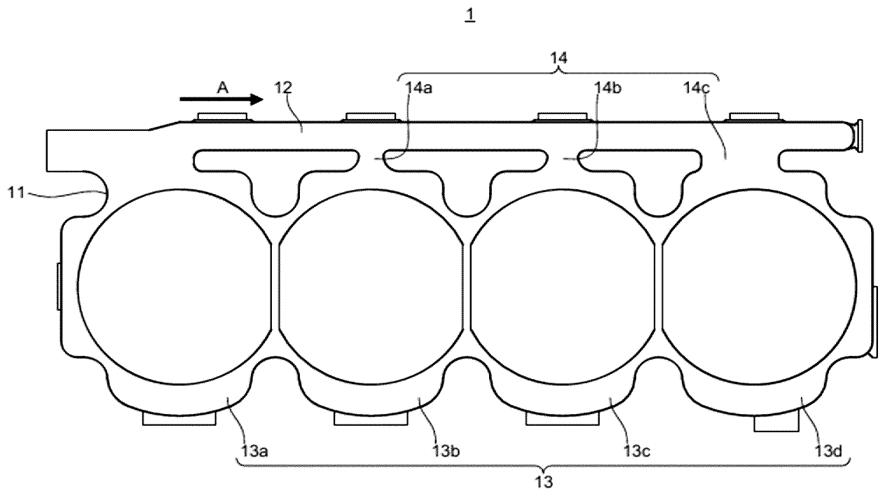

### TECHNICAL FIELD

The present disclosure relates to a flow channel structure and a cylinder block through which cooling water flows.

### BACKGROUND ART

Traditionally, providing a flow channel through which cooling water for cooling an engine flows in components (e.g., cylinder block and cylinder head) of an engine has been known (e.g., see, Patent Literature (hereinafter, referred to as “PTL”) 1.

As an example of such a flow channel, a flow channel structure including a plurality of water jackets and a single bypass passage communicating with each of the water jackets has been known.

### CITATION LIST

### Patent Literature

Japanese Patent Application Laid-Open No. H7-259555

### SUMMARY OF INVENTION

### Technical Problem

The flow channel structure mentioned above has a problem in that the flow rates of cooling water in the water jackets vary or a pressure loss in the bypass passage increases.

An object of one aspect of the present disclosure is to provide a flow channel structure and a cylinder block that can equalize the flow rates of cooling water in water jackets and reduce a pressure loss in a bypass passage.

### Solution to Problem

A flow channel structure according to one aspect of the present disclosure is a structure which is provided in a component of an engine and through which cooling water used for cooling the engine flows, the flow channel structure including: a plurality of water jackets; a single bypass passage provided parallel to the plurality of water jackets; a branch passage that causes the cooling water pressure-fed by a water pump to branch off and flow into a most upstream one of the plurality of water jackets and a most upstream part of the bypass passage; and a plurality of connection passages connecting between the plurality of water jackets on one side and the bypass passage on the other side, in which the plurality of connection passages are connected to the bypass passage at positions different from each other from upstream to downstream of the bypass passage, and flow channel cross-sectional areas of the plurality of connection passages are larger in size toward a downstream side of the bypass passage.

A cylinder block according to one aspect of the present disclosure includes the flow channel structure according to the above aspect of the present disclosure.

### Advantageous Effects of Invention

According to the present disclosure, it is made possible to equalize the flow rates of cooling water in water jackets and to reduce a pressure loss in a bypass passage.

### BRIEF DESCRIPTION OF DRAWINGS

The figure is a top view of a flow channel structure according to an embodiment of the present disclosure.

### DESCRIPTION OF EMBODIMENT

Hereinafter, flow channel structure 1 of an embodiment of the present disclosure will be described with reference to the figure. The figure is a top view of flow channel structure 1 of this embodiment.

Flow channel structure 1 is provided, for example, in a cylinder block (exemplary engine component, and illustration thereof is omitted) of an automobile. Although illustration is omitted, such a cylinder block is connected to cylinder heads via a cylinder gasket.

Flow channel structure 1 includes branch passage 11, bypass passage 12, water jackets 13 (13a, 13b, 13c, and 13d), and connection passages 14 (14a, 14b, and 14c) as a flow channel through which cooling water used to cool the engine flows.

Branch passage 11 is the most upstream flow channel in flow channel structure 1 and is connected to water jacket 13a, which is the most upstream one of water jackets 13, and branch passage 11 is also connected to the most upstream part of bypass passage 12.

Cooling water cooled by a radiator (illustration is omitted) and pressure-fed by a water pump (illustration is omitted) flows into branch passage 11. Branch passage 11 causes this cooling water to branch off and flow into both water jacket 13a and the most upstream part of bypass passage 12.

Bypass passage 12 is a single straight flow channel and is provided parallel to water jackets 13. As mentioned above, the most upstream part of bypass passage 12 is connected to branch passage 11.

Arrow A illustrated in the figure indicates a flow direction of cooling water in bypass passage 12. That is, in bypass passage 12, the cooling water flows from left to right in the figure.

In bypass passage 12, connection passages 14a, 14b, and 14c are connected at positions different from each other from upstream to downstream of bypass passage 12.

Note that, a flow channel cross-sectional area of a portion of branch passage 11 connected to water jacket 13a (hereinafter, referred to as “flow channel cross-sectional area of connection portion”) is larger than a flow channel cross-sectional area of bypass passage 12. In a case where the flow channel cross-sectional area of the connection portion is small, a large amount of cooling water adversely flows into bypass passage 12, resulting in an increase in pressure loss. Enlarging the flow channel cross-sectional area of bypass passage 12 to avoid such case adversely results in decrease in the flow rates of cooling water in water jackets 13. In order to secure appropriate flow rates in water jackets 13, it is necessary to split the cooling water at a position where the water pressure is high (position closest to the water pump in flow channel structure 1). Therefore, the flow channel cross-sectional area of the connection portion and the flow channel cross-sectional area of bypass passage 12 are properly adjusted taking into account various balances mentioned above.

Water jackets 13 are each a flow channel provided along around an engine cylinder (illustration is omitted).

Water jackets 13 include four water jackets 13a, 13b, 13c, and 13d, corresponding to the number of cylinders.

As mentioned above, branch passage 11 is connected to water jacket 13a, which is the most upstream water jacket. Further, water jacket 13a is connected to water jacket 13b. Water jacket 13b is then connected to water jacket 13c. Water jacket 13c is then connected to water jacket 13d.

Further, water jackets 13b, 13c, and 13d are connected respectively to connection passages 14a, 14b, and 14c.

Connection passages 14 include three connection passages 14a, 14b, and 14c corresponding to the number of water jackets 13b, 13c, and 13d downstream of water jacket 13a, which is the most upstream water jacket.

Connection passages 14a, 14b, and 14c are flow channels that connect between water jackets 13b, 13c, and 13d, respectively, on one side and bypass passage 12 on the other side. As mentioned above, connection passages 14a, 14b, and 14c are connected to bypass passage 12 at positions different from each other from upstream to downstream of bypass passage 12.

The flow channel cross-sectional areas of connection passages 14a, 14b, and 14c are different from each other. Specifically, the flow channel cross-sectional area of connection passage 14a is smaller than that of connection passage 14b, and the flow channel cross-sectional area of connection passage 14b is smaller than that of connection passage 14c. That is, the flow channel cross-sectional areas of connection passages 14 are designed to be larger in size from the upstream side to the downstream side of bypass passage 12.

As described above, flow channel structure 1 of the present embodiment is a flow channel structure which is provided in a component (e.g., cylinder block) of an engine and through which cooling water used for cooling the engine flows. Flow channel structure 1 of the present embodiment is characterized by including: a plurality of water jackets 13; a single bypass passage 12 provided parallel to the plurality of water jackets 13; branch passage 11 that causes the cooling water fed by pressure using a water pump to branch off and flow into water jacket 13a, which is the most upstream one of the plurality of water jackets 13, and the most upstream part of bypass passage 12; and a plurality of connection passages 14 connecting between the plurality of water jackets 13 on one side and bypass passage 12 on the other side. Flow channel structure 1 of the present embodiment is characterized in that the plurality of connection passages 14 are connected to bypass passage 12 at positions different from each other from upstream to downstream of bypass passage 12, and flow channel cross-sectional areas of the plurality of connection passages 14 are larger in size toward the downstream side of bypass passage 12.

In other words, in flow channel structure 1, the flow channel cross-sectional area of a connection passage connected to an upstream portion of bypass passage 12 where the water pressure is high and which is closer to a water pump (e.g., connection passage 14a) is narrow, and the flow channel cross-sectional area of a connection passage connected to a downstream portion of bypass passage 12 where the water pressure is low and which is far from the water pump (e.g., connection passage 14b) is wide. Therefore, it is made possible to equalize the flow rates of cooling water in water jackets 13 and reduce the pressure loss in bypass passage 12.

In addition, the equalization of the flow rates of cooling water can be realized not only in the cylinder block equipped with flow channel structure 1 but also in the cylinder heads connected to the cylinder block. Specifically, adjusting hole diameters of a head gasket provided between the cylinder heads and the cylinder block can equalize the flow rates.

Note that, the present disclosure is not limited to the above embodiment, and various modifications can be made without departing from the spirit of the present disclosure.

This application is based on the Japanese Patent Application filed on Dec. 27, 2021 (Patent Application No. 2021-212684), the contents of which are hereby incorporated by reference.

### INDUSTRIAL APPLICABILITY

The present disclosure is useful for a flow channel structure and a component of an engine through which cooling water flows.

### REFERENCE SIGNS LIST

1 Flow channel structure
11 Branch passage
12 Bypass passage
13, 13a, 13b, 13c, 13d Water jacket
14, 14a, 14b, 14c Connection passage

1. A flow channel structure which is provided in a component of an engine and through which cooling water used for cooling the engine flows, the flow channel structure comprising:
a plurality of water jackets;
a single bypass passage provided parallel to the plurality of water jackets;
a branch passage that causes the cooling water pressure-fed by a water pump to branch off and flow into a most upstream one of the plurality of water jackets and a most upstream part of the bypass passage; and
a plurality of connection passages connecting between the plurality of water jackets on one side and the bypass passage on the other side, wherein
the plurality of connection passages are connected to the bypass passage at positions different from each other from upstream to downstream of the bypass passage, and
flow channel cross-sectional areas of the plurality of connection passages are larger in size toward a downstream side of the bypass passage.

2. The flow channel structure according to claim 1, wherein a flow channel cross-sectional area of a connection part of the branch passage with the most upstream one of the plurality of water jackets is larger than a flow channel cross-sectional area of the bypass passage.

3. A cylinder block, comprising the flow channel structure according to claim 1.
